(19) United States
(12) Patent Application Publication
(10) Pub. No.: US 2008/0192461 A1
(43) Pub. Date: Aug. 14, 2008

(54) Portable worklight with two switchable lightsources

(76) Inventor: Chao Chuan Chien, Hsin Chuang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/802,589

(22) Filed: May 23, 2007

(30) Foreign Application Priority Data
Feb. 14, 2007 (TW) 096202831

(51) Int. Cl. F21L 4/00; F21S 4/00; F21V 29/00

(52) U.S. Cl. 362/183; 362/218; 362/223

(57) ABSTRACT

The present invention discloses a portable worklight with two switchable lightsources, comprising a main body, a flexible compound cable, and a lampshade. The main body is disposed with a power supply unit to provide power to a main circuit board, which is coupled with the switch through power cords. The compound cable is connected to the top of the main body and the end of the lampshade, respectively, and is coupled with the switch and the first and second light source modules. The cable is coaxially disposed with a first and a second conductors, between which an inner insulated layer is provided; also, a third conductor is inserted into the inner insulated layer and an external insulated layer is wrapped over the second conductor. The inner chamber of the lamp holder of the lampshade is stackingly disposed with the first and second light source modules. Consequently, the switch may be used to selectingly turn on/off the first light source module or the second light source module.

### FIELD OF THE INVENTION

The present invention relates to a portable worklight and in particular to a portable worklight with two switchable lightsources.

### BACKGROUND OF THE INVENTION

Lamps have a variety of forms to suit different needs, floor lamp, wall lamp, table lamp, desk lamp, and many others. To meet the demand of a working place, the lamp design usually requires specific functions. For a car maintenance workshop, for example, the lamps on the workshop usually do not satisfy the need of the maintenance work since the car body or cover, an engine hood or a trunk cover for example, may obstruct the light coming from the lamps on top, and thus the lamps cannot light the area required. Consequently, the emergence of worklight is to meet this specific demand. A conventional worklight usually uses a tungsten wire as light source covered with a mesh metal cage thereon for the protection of its bulb. A hook is disposed on its end for hanging the lamp at the maintenance site to provide lighting. Some operators use a desk lamp instead of worklight and take the advantage of the flexibility of its flexible metallic conduct to change the projection angle of the light. Since the flexible metallic conduct is a hollow structure, in which a power cord runs through, and thus the angle adjustment is restricted by the structure of the flexible metallic conduct itself, leading to a limited change of working angle. Furthermore, if the working angle exceeds its limit, the flexible metallic conduct or power cord may break as a result.

Vehicle maintenance is not limited in handling materials, replacing parts or oil for example. It is sometimes necessary to inspect tubes; for example, in the inspection of the leaking of the refrigerant circulation tubes of the air-condition system, fluorescent agent is first injected into the circulation tubes to mix with fluid in the tubes, and an ultraviolet (UV) tube is projected onto the tubes. In the case of finding a fluorescent agent on certain spots on the tubes, it can be sure that cracks near the spots are responsible for the leaking of fluorescent agent.

Consequently, an ordinary vehicle maintenance site requires both kinds of worklight for conventional lighting and inspecting tube leaking. Purchasing both kinds of worklights will certainly add to the cost, and also the UV worklight is not routinely used. Consequently, it is necessary to design a new electrical connector to overcome the shortcomings described above.

### SUMMARY OF THE INVENTION

To meet such a demand, the applicant has a long time experience in designing, production, and marketing of the power supply device and lamp design, and understand the drawbacks that different worklights for different purposes are required for some working places, vehicle maintenance shops for example. Thus the applicant proposes the present invention, a portable worklight with two switchable lightsources, which provides double lightsources in a single worklight and adopts a flexible compound cable to replace conventional flexible metallic conduct to increase its service life, as a result of numerous trials and experiments. In order to achieve the object described above, the present invention provides a portable worklight with two switchable lightsources, comprising a main body having a long shell body, in which a power supply unit is disposed to supply power to a main circuit board, which is then further coupled with a switch; a flexible cable coaxially disposed with a first and a second conductors, between which an inner insulated layer is provided, and having a third conductor, which is inserted into the inner insulated layer, and an external insulated layer wrapped over the second conductor, with the end of the cable is connected on the top of the main body and coupled with the switch; and a lampshade having a lamp holder, into which the top of the compound cable is inserted, with the inner chamber of the lamp holder stackingly disposed with the first and second light source modules, which the first light module is coupled with the first and second conductors, and the second light source is coupled with the first and third conductors. Consequently, the switch may be used to selectingly turn on/off the first light source module or the second light source module.

### BRIEF DESCRIPTION OF THE DRAWINGS

The present invention can be more fully understood by reference to the following description and accompanying drawings, in which:

FIG. 1 schematically illustrates an exploded perspective view of a portable worklight with two switchable lightsources according to the present invention;

FIG. 2 schematically illustrates a cross-sectional view of the assembly of a portable worklight with two switchable lightsources according to the present invention;

FIG. 3 schematically illustrates a cross-sectional view of the compound cable according to the present invention;

FIG. 4 schematically illustrates a cross-sectional view of the two lightsources in the lampshade according to the present invention; and

FIG. 5 schematically illustrates a perspective assembly view of a portable worklight with two switchable lightsources according to the present invention.

### DETAILED DESCRIPTION OF THE PREFERRED EMBODIMENTS

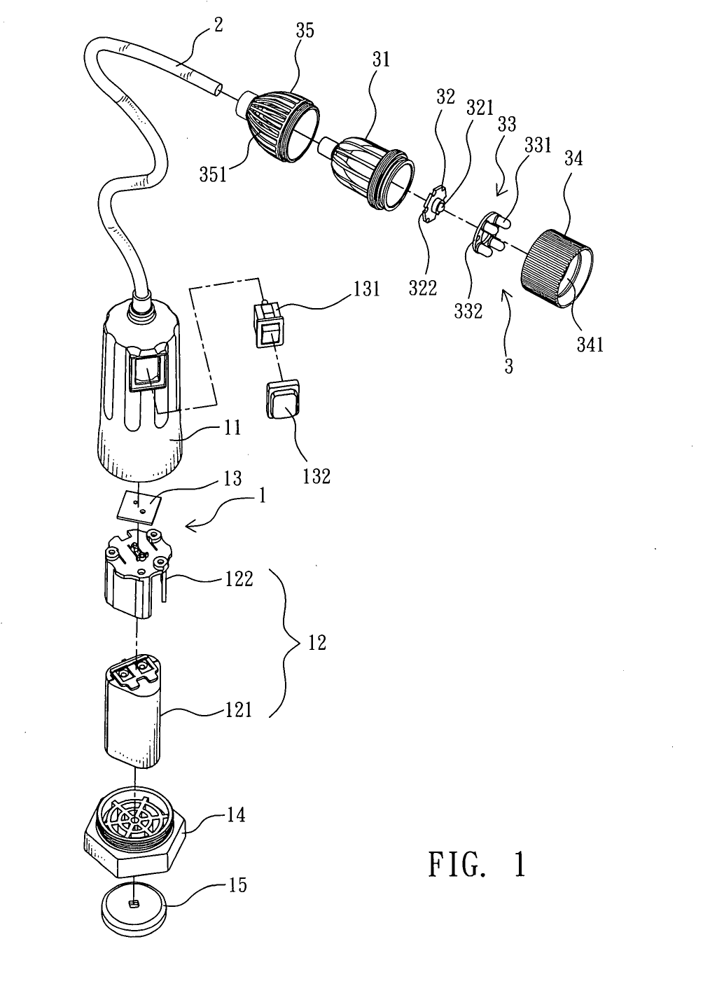

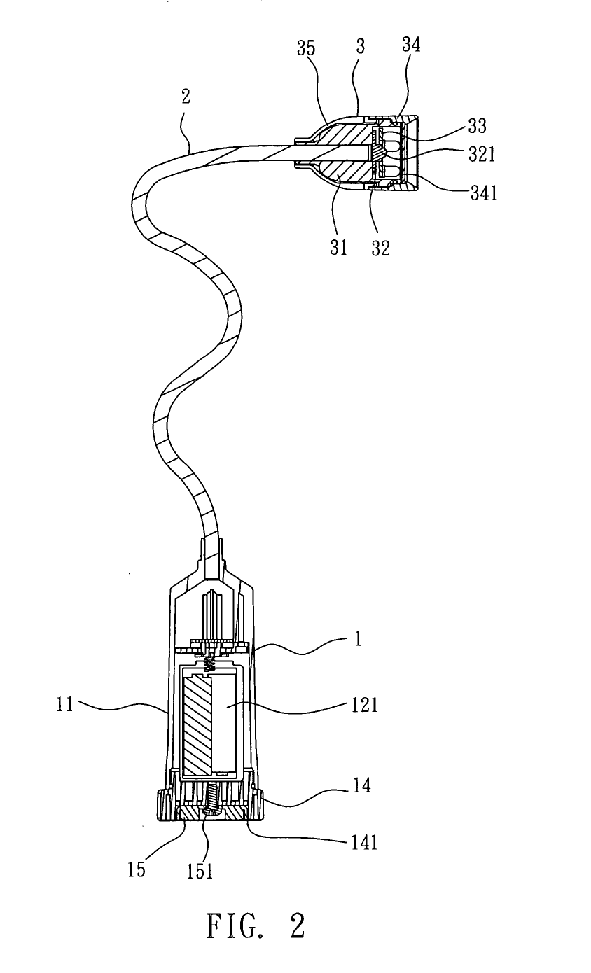

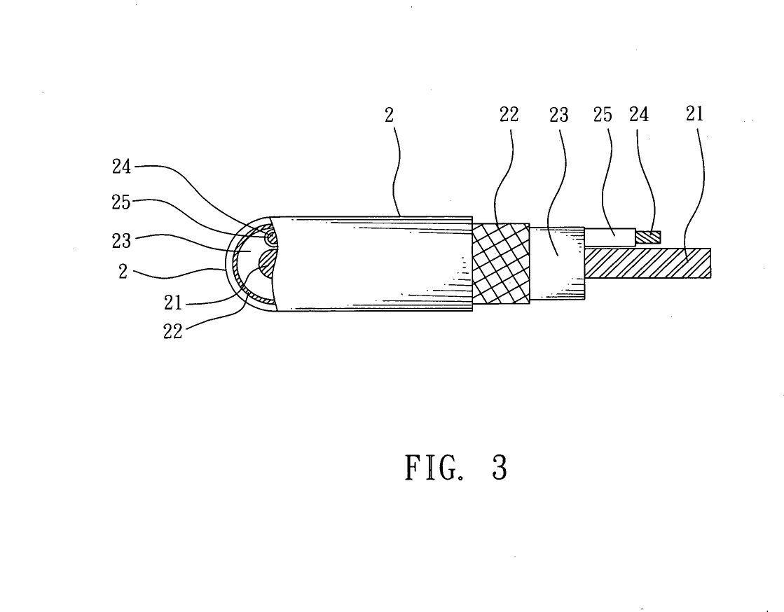

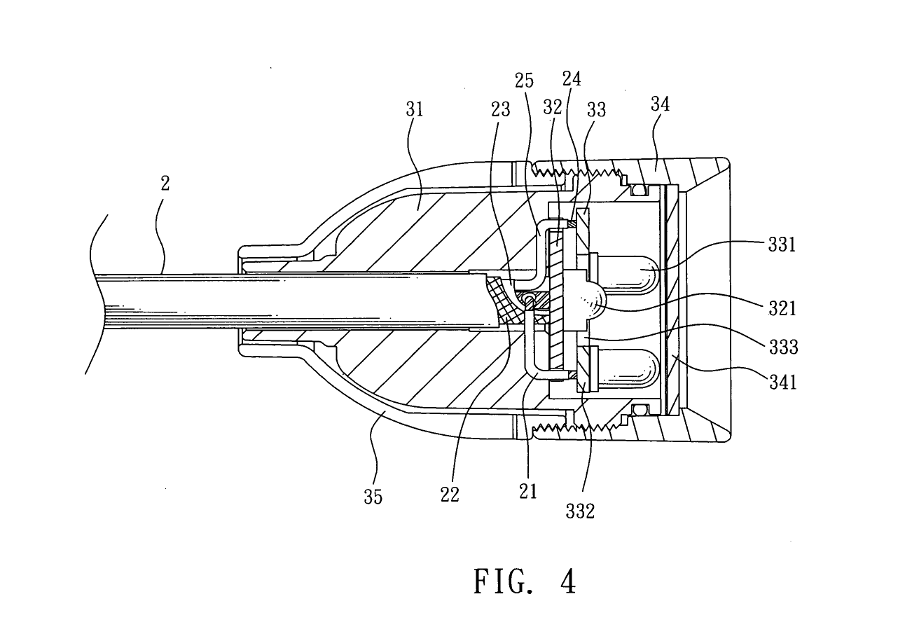

With reference to FIGS. 1 to 4, a portable worklight with two switchable lightsources according to the present invention comprises a main body 1, a compound cable 2, and a lampshade 3, wherein the main body 1 has a long shell body 11, in which a power supply unit 12, for example but not limited to, a battery or rechargeable battery 121. As shown in FIG. 1, the power supply unit 12 is a rechargeable battery 121, which is preferably shaped as a triangular prism, with its positive and negative terminals attached on its top and insertingly mounted onto a rechargeable battery seat 122, which is also a triangular shape. The battery seat 122 is connected to a main circuit board 13 disposed on the top of the battery seat 122 with electrical wires, and supplies power to the main circuit board 13, which is further coupled with a three-stage switch 131, over which is coveringly mounted with a switch cover 132 to prevent moisture or dust from affecting the function of the switch 131, to selectingly turn on or off a first light source module 32 and second light source module 33 described later. Furthermore, the shell body 11 is sealed on its bottom with an end cover 14. The bottom chamber 141 formed by the shell body 11 and the end cover 14 is disposed with a magnet 15, for example, through which a connection part 151, a screw for example, is connected and fastened onto the end cover 14 by penetrating the magnetic object 151. The advantage of disposing a magnetic object 151 on the bottom of the main body 1 of the portable worklight according to the present invention is to render the worklight suckingly attached on the metal part of car body; thus maintenance work can be carried out without the need to carry worklight constantly.

With reference to FIGS. 1 to 3, the compound cable 2 is disposed in its middle with a flexible first conductor 21, a highly conductivity copper bar for example, and is disposed a second conductor 22, a metal mesh net for example. A soft polymer insulating layer 23, made of PVC for example, is disposed between the first conductor 21 and the second conductor 22. Another third conductor 24, an electrical wire covered with insulated wrapping, is wrapped with the inner insulating layer 23. The exterior of the second conductor 22 is wrapped with a soft polymer material, an external insulated layer 25 for example, to form the compound cable 2 according to the present invention. The end of the cable 2 is connected on the top of the main body 1 and coupled with a switch 131; for example, the first conductor 21 is coupled with the positive terminal and the second and third terminals 22, 23 are coupled with a respective negative terminal. Since the outer diameter of the first conductor 21 is relatively large, its flexibility may extend the range of adjusting working angle. Furthermore, the second conductor 22 is made of metal mesh net, which can be easily bended without breaking. Consequently, with the implementation of the first and second conductors 21 and 22, their characteristic of flexibility is starkly different from that of the conventional flexible metallic conduct; the first and second conductors 21 and 22 have excellent flexibility and are resistant to breaking apart from their electrical conductivity.

With reference to FIGS. 1, 2, and 4, the lampshade 3 has a lamp holder 31, into which the top of the compound cable 2 is inserted. The lamp holder 31 is preferably made of metal with high thermal conductivity, aluminum alloy for example, in which the first light module 32 and the second light module 33 are stackingly disposed. The first light module 32 has a first light source 321, a high-brightness LED light for example, coupled with the first and second conductors, 21 and 22. To enable the third conductor 24 passing through the first light source module 32, around whose circumference is cut at least a board slot 322. The second light source module 33 comprises a multiple of the second light sources 331, an ultraviolet (UV) light for example, fixed on a second circuit board 332 and coupled with the first and third conductors 21, 24, respectively. The second light source module 33 is formed to have a slot hole 333 on its center for the protrusion of the first light source 321. Consequently, with the control of the three-stage switch 131, one may choose to turn on/off the first light source 321, LED light for example, or the second light source 331, UV light for example. Moreover, the first light module 32 is contacted with the inner wall of the lamp holder 31 such that the heat generated from the light may be transmitted to the lamp holder 31 and thus dissipated away.

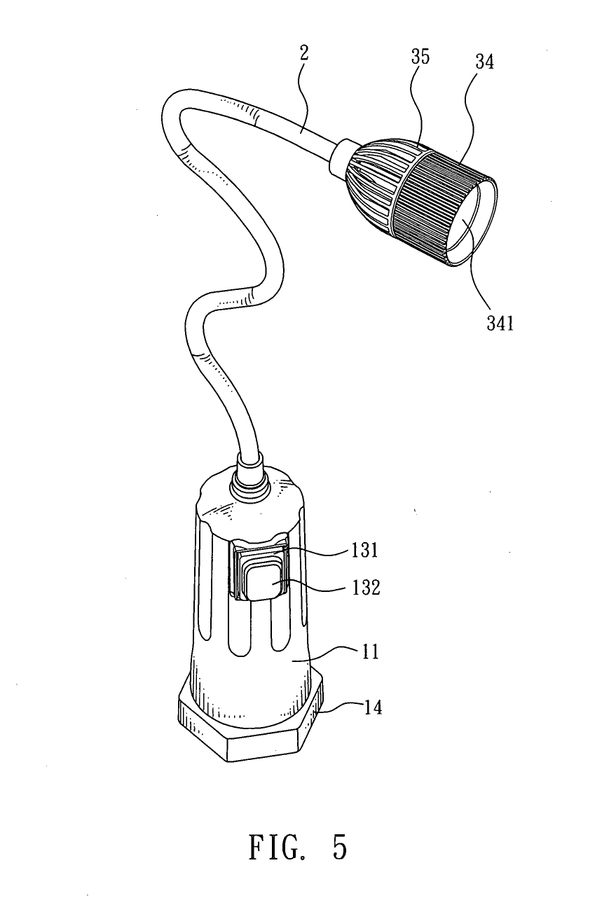

To protect the first and second light modules 32 and 33, the lampshade 3 is further disposed with a front shade 34 attached on the front end of the lamp holder 31 and a lens 341 is disposed inside the front shade 34 to prevent water or foreign objects from entering thereinto. Moreover, an insulated rear shade 35 is coveringly mounted on the lamp holder 31 to avoid burn as a result of direct contact with the lamp holder 31. A multiple of heat dissipating slots 351 are formed on the surface of the rear shade 35 to promote heat dissipation and to effectively prevent direct contact with the lamp holder 31. As shown in the figures, the front shade 34 is connected with both the lamp holder 31 and the back lampshade 35, such that individual components may be securely fastened without the risk of falling apart. The overall appearance of the present invention after assembly is shown in FIG. 5.

With reference to the accompanied figures, when the present invention is being used, one may select the suitable light source by using the switch 131. When one conducts maintenance work on the engine of a car, for example, the present invention may be attached onto an appropriate position of the car body by the magnet 15 on the bottom of the main body 1 and use the switch 131 to select the first light module 32 to turn on the first light source 321 and thus provide suitable lighting for maintenance work. On the other hand, when inspecting tubes leaking, one may select the second light source module 33 by the switch 131 to turn on the light source 331 so as to inspect whether fluorescent agent is leaking or not.

Consequently, with the implementation of a portable worklight with two switchable lightsources, users need not to use separate worklight for lighting and inspection, such that the cost can be reduced. Also, the compound cable itself has the characteristic of flexibility, and, in particular, the first conductor is a metal which is highly flexible and which is a common terminal for both light source modules. The second conductor is a metal mesh net, which is capable of bending with the risk of breaking. Consequently, the first and second conductors may replace the conventional flexible metallic conduct and also have the capability of electrical conductivity. Furthermore, the bottom of the main body is connected with a magnetic object, a magnet for example, to enable the main body suckingly attached onto a car body, such that users mat need to hold worklight when conducting maintenance or inspection. Moreover, the first and second light source modules are stackingly disposed and fastened inside the shade with a front shade at its front to protect the light sources and a rear shade on its back to cover the shade for heat insulation and heat dissipation, which makes a breakthrough to conventional art.

While the invention has been described with reference to the a preferred embodiment thereof, it is to be understood that modifications or variations may be easily made without departing from the spirit of this invention, which is defined by the appended claims.

What is claimed is:

1. A portable worklight with two switchable lightsources, comprising
a main body having a long shell body, in which a power supply unit is disposed to supply power to a main circuit board, which is then further coupled with a switch;
a flexible cable coaxially disposed with a first and a second conductors, between which an inner insulated layer is provided, and having a third conductor, which is inserted into the inner insulated layer, and an external insulated layer wrapped over the second conductor, with the end of the cable is connected on the top of the main body and coupled with the switch; and
a lampshade having a lamp holder, into which the top of the compound cable is inserted, with the inner chamber of the lamp holder stackingly disposed with the first and second light source modules, which the first light module is coupled with the first and second conductors, and the second light source is coupled with the first and third conductors; consequently, the switch may be used to selectingly turn on/off the first light source module or the second light source module.

2. The portable worklight with two switchable lightsources according to claim 1, wherein the power supply unit is a battery or rechargeable battery.

3. The portable worklight with two switchable lightsources according to claim 2, wherein the power supply unit is a rechargeable battery and shaped as a triangular prism, with its positive and negative terminals attached on its top and being insertingly mounted onto a rechargeable battery seat, which is also a triangular shape.

4. The portable worklight with two switchable lightsources according to claim 1, wherein the switch is coveringly mounted with a switch cover on its exterior.

5. The portable worklight with two switchable lightsources according to claim 1, wherein the end of the shell body is sealed with an end cover to form a bottom chamber at bottom to receive and position a magnetic object.

6. The portable worklight with two switchable lightsources according to claim 1, wherein the first conductor is a copper bar with a relatively large diameter, the second conductor is a metal mesh net, and the third conductor is a power cord wrapped with insulated material.

7. The portable worklight with two switchable lightsources according to claim 1, wherein the first conductor is coupled with the positive terminal of the switch and the second and third conductors are coupled with the negative terminal of the switch, respectively.

8. The portable worklight with two switchable lightsources according to claim 1, wherein the lamp holder is made of metal with high electrical conductivity and contacted with the first light source module.

9. The portable worklight with two switchable lightsources according to claim 1, wherein the first light module has a first light source coupled with the first and second conductors and is cut at its circumference to form at least a board slot for the passing of the third conductor; and the second light source module comprises a multiple of the second light sources fixed on a second circuit board and coupled with the first and third conductors, respectively, with a slot hole 333 formed on its center for the protrusion of the first light source.

10. The portable worklight with two switchable lightsources according to claim 9, wherein the first light source is a high-brightness LED and the second light source is an ultraviolet light.

11. The portable worklight with two switchable lightsources according to claim 1, wherein the lampshade is attached with a front shade on its front end, inside which a lens is disposed.

12. The portable worklight with two switchable lightsources according to claim 1, wherein an insulated rear shade is coveringly mounted on the lamp holder and a multiple of heat dissipating slots are formed on the surface of the rear lamp to promote heat dissipation.
